(19) United States
(12) Patent Application Publication
(10) Pub. No.: US 2003/0065848 A1
(43) Pub. Date: Apr. 3, 2003

(54) Transmission method and apparatus utilizing a two-line bus shared for power supply and data transmission

(76) Inventor: Yoshiki Mori, Sapporo (JP)

Correspondence Address: Yoshiki Mori, c/o Gyrotec, 1-2-1-218 Aobadai aobaku, Yokohama, 227-0062, JP

(21) Appl. No.: 10/254,338

(22) Filed: Sep. 25, 2002

(30) Foreign Application Priority Data
Sep. 30, 2001 (JP) 2001-340035

(51) Int. Cl. G06F 13/36

(52) U.S. Cl. 710/113

(57) ABSTRACT

A data transmission apparatus utilizing a two-line bus (17, 18) shared for power supply and data transmission is provided. This apparatus includes a two-line bus (17, 18), a plurality of terminals (11 through 16) connected to the two-line bus (17, 18), a bus controller (10), which is connected to the two-line bus (17, 18) and which outputs a predetermined single-bit logical signal that indicates the start of data transmission to the two-line bus or the start of arbitration of requests for right of use of said two-line bus during the first time period and which supplies electric power during the second time period; wherein the first time period is continuous with the second time period. This transmission system is characterized by the pairing of a single-bit transmission time period and a power supply time period for data transmission.

### BACKGROUND OF THE INVENTION

1. Field of the Invention

The present invention relates to a data transmission method and related apparatus, more specifically it relates to a data transmission method and related apparatus utilizing a small number of transmission lines shared for power supply and signal transmission.

2. Description of the Related Art

Conventionally, special and dedicated cables and connectors for data transmission are needed for connecting among a large number of terminals, which need an electric power supply, connections among actuators, sensors, and a control apparatus thereof, or connections between a control panel and a control apparatus thereof.

In the case where a lot of cables are used in the inside or outside of a building, or within equipment, those cables are generally combined into bunched cables, which are thick and heavy. Moreover, extra room for placement of the bunched cables is required. In addition, it is troublesome to check that each of the bunched cables is correctly connected. Furthermore, in the case where there is a lot of equipment that needs to be connected with cables, complicated cable forks develop. It is also difficult to effectively reduce radiation noise, which is given off from a variety of systems.

### BRIEF SUMMARY OF THE INVENTION

A transmission method and the related apparatus according to the present invention have the following configurations, considering the problems described above. This method is a two-line bus data transmission method where a two-line bus is shared for power supply and data transmission, and includes the steps of transmitting single-bit data via a two-line bus during the first time period, and supplying electric power via a two-line bus during the second time period. Note that the first and second time periods are continuous.

The apparatus is a two-line bus data transmission apparatus where a two-line bus is shared for power supply and data transmission, and includes a two-line bus, at least one terminal connected to the two-line bus, and a bus controller, which is connected to the two-line bus and which outputs a predetermined logic signal indicating the start time for the first time period for single-bit data transmission via the two-line bus and also the start time for arbitrating requests for using the two-line bus.

### BRIEF DESCRIPTION OF THE DRAWINGS

FIG. 1 shows an outline of a data transmission system according to an embodiment of the present invention;

FIG. 2 shows a configuration of a power supply and bus controller according to an embodiment of the present invention;

FIG. 3 shows a configuration of a terminal according to an embodiment of the present invention;

FIG. 4 shows a configuration of a single bit, transmission timing, and the operation of relevant elements in the case where the data transmission system according to an embodiment of the present invention transmits a single bit of low logic level signal;

FIG. 5 shows a configuration of a single bit, transmission timing, and the operation of relevant elements in the case where the data transmission system according to an embodiment of the present invention transmits a single bit of high logic level signal;

FIG. 6 shows a configuration and timing of the start bit in a bus arbitration mode, and operations of related elements;

FIG. 7 shows a configuration and timing of a single byte of data to be transmitted in a data transmission mode;

FIG. 8 shows a configuration and timing of data to be transmitted to transmission line 17 in a bus arbitration/acquisition mode;

FIG. 9 shows a configuration and timing of data to be transmitted to transmission line 17 in a bus arbitration/continuous in-use mode;

FIG. 10 shows a configuration and timing of data to be transmitted to transmission line 17 in a bus arbitration/re-transmission mode;

FIG. 11 shows an example of a configuration where additional power lines are interconnected in a data transmission system according to the present invention; and a plurality of equipment is controlled by each terminal;

FIG. 12 shows an embodiment where sensors and actuators are connected to respective terminals of a data transmission system according to the present invention;

FIG. 13 is a flowchart describing the summary of an operation of the power supply and bus controller unit 10, according to an aspect of the present invention;

FIG. 14 is a flowchart describing the summary of an operation of each terminal, according to an aspect of the present invention; and

FIG. 15 is a flowchart describing a transmission operation of a terminal in the bus arbitration/acquisition mode and data transmission mode.

### DETAILED DESCRIPTION OF THE PRESENT INVENTION

A transmission method and related apparatus, according to an embodiment of the present invention, is implemented by connecting a plurality of terminals using two wires arranged in a straight line, in a radial pattern, in a tree pattern, etc. and allowing the two wires to be shared for supplying electric power and transmitting signals on a time-sharing basis.

According to an aspect of the present invention, a transmission method is characterized by the pairing of a single-bit transmission time period with a power supply time period for data transmission. In the following, the basic structure of the present invention is described. One of the two wires is used to transmit data as well as supply electric power, and the other one is used as a ground line. The transmission wire is electrically pulled up, thereby allowing a wired-OR logic on the transmission wire to function normally among a plurality of terminals so that a bus arbitration/acquisition mode can be implemented by checking the level of the transmission wire in relation to the plurality of terminals at the same time. Digital values of a high and a low level are transmitted through the transmission wire. A pulling-up configuration is used to drive the transmission wire to a high level. Use of this pulling-up configuration, is weak against external noise interference and difficult to transmit high-level data at high speeds, while there may be no problem with low-level data transmission. In order to solve this problem, this transmission method of the present invention has the aforementioned configuration of a single bit transmission time period and a single power supply time period for data transmission. With this configuration, since the parasitic capacitors and inductors of the transmission wire are deeply charged to a high level during the previous power supply time period, high-level data transmission can be securely attained without driving the transmission wire by a terminal during a subsequent data transmission time period. However, this method is not capable of securely transmitting the combination of a plural-bit transmission time period and a single power supply time period at high speeds, since if a low-level bit and then a high-level bit are continuously transmitted after the power supply time period, the latter high level cannot securely reach a high speed. Therefore, the aforementioned configuration of a single bit transmission time period and a single power supply time period for data transmission according to the present invention is very effective.

FIG. 1 shows an outline of a transmission method of the present invention. Reference numeral 10 denotes a power supply and bus controller unit according to this embodiment of the present invention. Reference numerals 11, 12, 13, 14, 15, and 16 denote terminals, according to these embodiments of the present invention. Reference numerals 17 and 18 denote wires (hereafter, referred to as transmission lines), which electrically connect between the power supply and bus controller unit 10 and each terminal 11, . . . , 16.

(Summary of Power Supply and Bus Controller Unit 10)

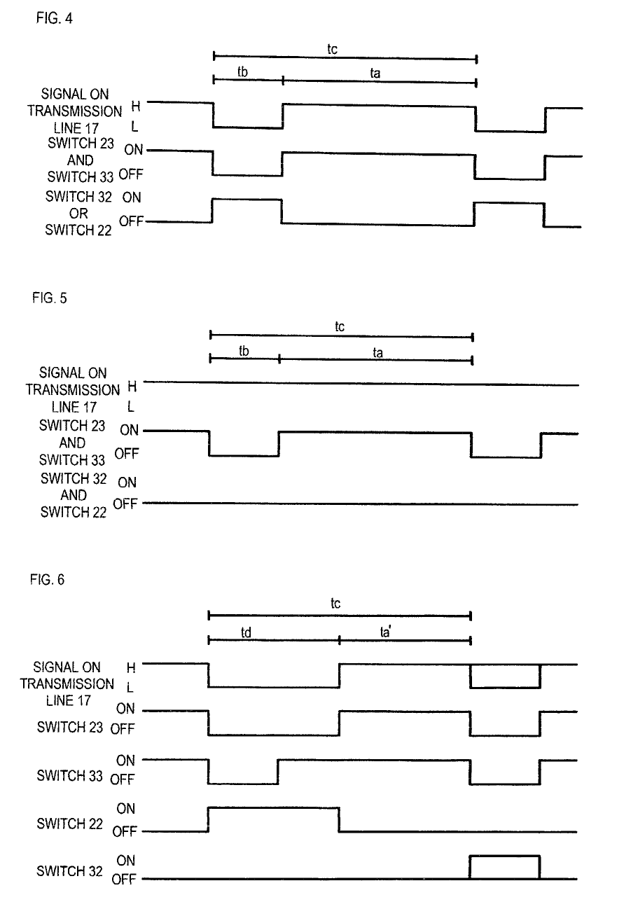

The power supply and bus controller unit 10 performs two main operations. The first operation is to supply electric power to each terminal 11, . . . , 16 via transmission lines 17 and 18 so that that each may operate correctly. The second operation is to arbitrate issued requests among terminals 11, . . . , 16 for utilization of transmission lines 17 and 18 when transmitting among those terminals via transmission lines 17 and 18. In order to implement these operations, the time period available is generally divided into two time periods: the first and second time periods. The first time period is a power supplying time period (ta shown in FIGS. 4 and 5), and the second time period is a signal transmission time period (tb also shown in FIGS. 4 and 5). These time periods are described in detail later.

(Details of Power Supply and Bus Controller Unit 10)

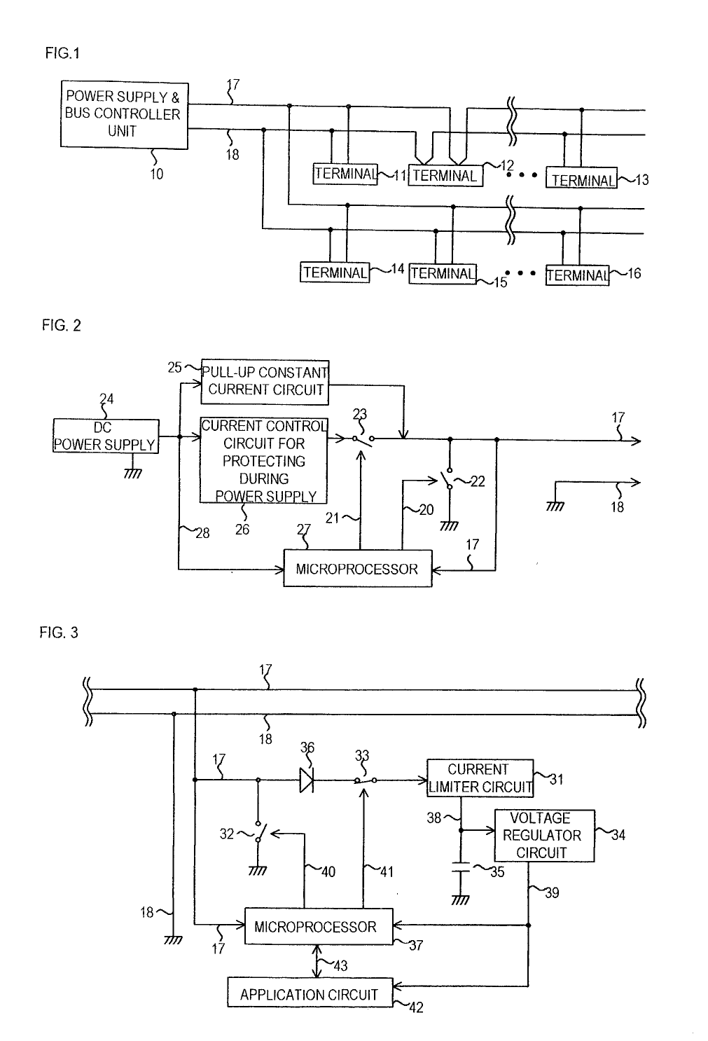

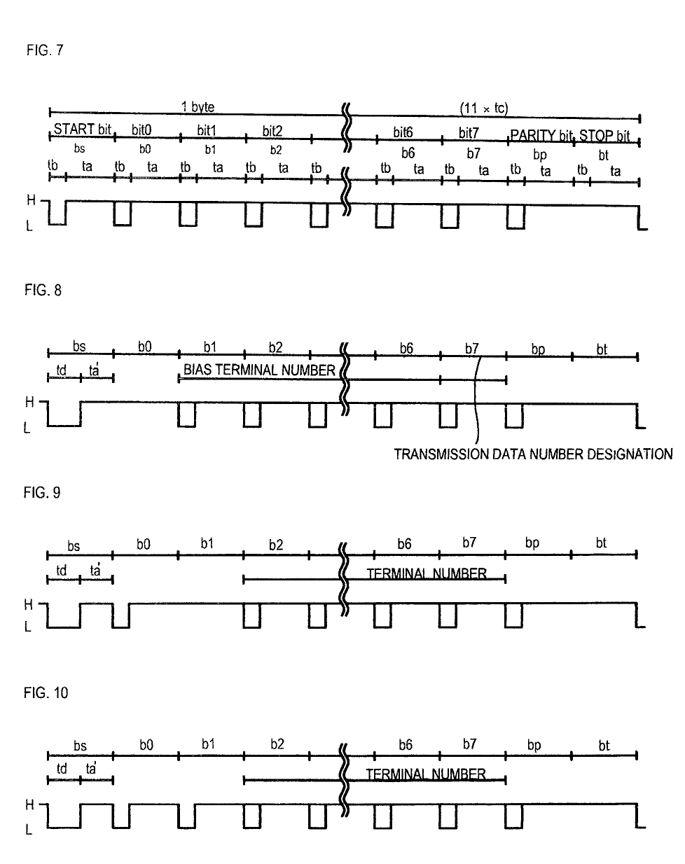

FIG. 2 shows an example of a detailed configuration of the power supply and bus controller unit 10. Reference numeral 24 denotes a DC power supply, which supplies direct current to each terminal 11, . . . , 16 respectively. The direct current from the DC power supply 24 is supplied to microprocessor 27 and constant current circuit 25 for pulling up during the signal time period. Current control circuit 26 protects the DC power supply and the transmission lines from being damaged. Current output from the circuit 26 is supplied to the transmission line 17 via a switch 23. The microprocessor controls the ON/OFF position of the switch 23. The signal pull-up constant current circuit 25 supplies a constant current (which is not necessary to always be constant) to transmission line 17, which is used to pull up the transmission line 17. This pulling up is needed for the above-mentioned transmission time period tb. The switch 22 is used to output a low logical level signal (during the time period tb of the start bit shown in FIG. 7) that designates the start of a data transmission mode, which is described later, and a low logical level signal (during td shown in FIGS. 8, 9, and 10) that designates the start of each bus arbitration mode. The microprocessor 27 controls the ON/OFF position of the switch 22. (An example of the detailed configuration of terminals 11, . . . , 16)

Next, a detailed example of configuration of the terminals 11, . . . , 16, which are connected to the transmission lines 17 and 18, is explained while referencing FIG. 3. A diode 36, which is connected to the transmission line 17, protects the terminals. Current is transmitted to a current control circuit (current limiter circuit) 31 via the protection diode 36. The current control circuit 31 controls the input current. The resulting controlled current is sent to capacitor 35 via line 38 so that the capacitor 35 is charged. Constant voltage circuit (voltage regulator circuit) 34 converts the voltage level at the capacitor 35 to a predetermined constant voltage level 34, and the resulting constant voltage is then supplied to microprocessor 37 and application circuit 42. The microprocessor 37 and application circuit 42 are driven with that constant voltage. The microprocessor 37 controls the ON/OFF position of the switch 33 via line 41. This ON/OFF position distinguishes the power supply time period ta from the signal transmission time period tb. For example, during the power supply time period ta the switch 33 is turned on, while during the signal transmission time period tb the switch 33 is turned off. The microprocessor 37 also controls the ON/OFF position of the switch 32 via line 40. With this control, the switch 32 is turned off during the power supply time period ta. In the case of transmitting a high-level signal via the transmission line 17 during the signal transmission time period tb, the switch 32 is turned off via line 40, while in the case of transmitting a low-level signal via the transmission line 17 during the signal transmission time period tb, the switch 32 is turned on via line 40. The microprocessor 37 of each terminal detects the start of the beginning of a low-level signal of the start bit tb driven by the power supply and bus controller unit 10, and determines the start of the bit 0 following a predetermined information time period tc.

(Transmission Method)

Here, it is explained how transmission among each terminal is performed, assisted by the power supply and bus controller unit 10, which arbitrates requests from the respective terminals for utilizing the transmission lines 17 and 18.

The basic transmission mode used in this embodiment is, for example, a start-stop serial transmission mode. As shown in FIGS. 4 and 5, according to an embodiment with this transmission mode of the present invention, a time period tc for a single-bit of information transmitted through transmission lines 17 and 18 includes the signal transmission time period tb and the power supply time period ta described above.

The power supply time period ta is the time period for charging a power supply capacitor 35 of each terminal. Since the longer the duration of the power supply time period ta within the single-bit information time period tc, the more advantageous it is to supply electric power to each terminal, the ratio of the power supply time period ta is set to, for example, three quarters (75%) of the single-bit information time period tc.

The signal transmission time period tb needs to be long enough to securely transmit signals via the transmission lines 17 and 18.

In the following, the operation of the transmission system of this embodiment is described while referencing the timing charts of FIGS. 4 and 5. FIGS. 4 and 5 are timing charts showing statuses of the electric power and signals transmitted to the transmission line 17, the ON/OFF status of the switch 33 (shown in FIG. 3) in each terminal, and the ON/OFF status of the switch 32 (shown in FIG. 3) in each terminal and the ON/OFF statuses of switches 22 and 23 (shown in FIG. 2) of the power supply and bus controller unit 10. FIG. 4 shows the case where a low logical level single-bit signal is output from a terminal to the transmission line, and FIG. 5 shows the case where a high logical level single-bit signal is output from a terminal to the transmission line.

With reference to FIGS. 4 and 5, during the power supply time period ta the switch 23 in the power supply and bus controller unit 10 is turned on, and the switch 33 in the terminal 11 is also turned on at the same time, charging the power supply capacitor 35 of each terminal.

With reference to FIG. 4, in the case of sending a low logical level signal during the signal transmission time period tb, by turning on either the switch 22 (in FIG. 2) or the switch 32 of a terminal, the transmission line 17 changes to low logical level. With reference to FIG. 5, in the case of sending a high logical level signal during the signal transmission time period tb, by turning off the switch 22 (in FIG. 2) and the switch 32 of each of the terminals (11 through 16), the pull-up constant current circuit 25 of the power supply and bus controller unit 10 (in FIG. 2) drives the transmission line 17 into a high logical level.

Note that since the power supply capacitor 35 of each terminal is not fully charged yet at the rising of the output from the DC power supply 24 of the power supply and bus controller unit 10, each microprocessor 37 does not operate yet. Accordingly, when each microprocessor 37 does not operate, the switch 33 for charging the power supply capacitor 35 remains on. At this time, the microprocessor 37 does not operate yet; however, a certain circuit configuration (not shown) instead is provided so that the switch 33 cannot turn off. Therefore, the single-bit information time period tc does not include the signal transmission time period tb until the power supply capacitor 35 of each of the terminals is fully charged so that the entire time period becomes a power supply time period ta (not shown). In other words, continuous repetition of power supply time period ta continues.

(Additional Connection of Terminal During Operation of Transmission System)

According to the transmission system of the present invention, even if that transmission system is currently operating, an additional terminal can be connected to the transmission lines 17 and 18. In other words, even during the signal transmission time period tb described above, an additional terminal can be connected to the transmission lines. In order to implement this, the pull-up constant current circuit 25 is provided with the capability of maintaining the transmission line 17 at high logical level while driving the load of a single terminal to which electric power is supplied.

(Arbitration of Requests from Each Terminal for Utilizing Transmission Line)

Since only one terminal is allowed to output data onto the transmission lines 17 and 18 at any given time, when a plurality of terminals simultaneously issue requests for utilizing the transmission lines 17 and 18, one of the terminals needs to be selected so as to provide the right of use of the transmission line to that terminal, in other words arbitration needs to be done. In the following, with reference to FIG. 6 this arbitration method is described.

For this arbitration, a time period for a bus arbitration/acquisition mode is prepared for the transmission line 17. Note that this bus arbitration mode includes a bus arbitration/acquisition mode (see FIG. 8), a bus arbitration/continuous in-use mode (see FIG. 9), and a bus arbitration/re-transmission mode (see FIG. 10); wherein the bus arbitration/acquisition mode is explained first, and the remaining two are explained later. Hereafter, the term ‘bus arbitration mode’ is used to include three modes: the bus arbitration/acquisition mode, the bus arbitration/continuous in-use mode, and the bus arbitration/re-transmission mode. In order to let all of the terminals know the time period for the bus arbitration/acquisition mode, an arbitration mode phase pattern (SIGNAL ON TRANSMISSION LINE in FIG. 6), which is different from the phase pattern of the single-bit information time period tc as shown in FIGS. 4 and 5, is provided. Since this arbitration mode phase pattern includes a time period (td in FIG. 6), the length of which is different from the signal transmission time period tb, such as a low logical level time period that is twice the signal transmission time period tb and that exists within the single-bit information time period tc, the bus arbitration mode can be identified. In this case, the power supply time period is shorter (ta′ in FIGS. 8 and 6); however, by using a pulse with that time period td only for the start bit of the arbitration mode phase pattern, smaller adverse influence on the power supply of each terminal is given. Hereafter, the time period td is referred to as a ‘bus arbitration mode identification time period’. The power supply and bus controller unit 10 outputs the td signal in the start bit to the transmission line 17. Then, each terminal detects the width of that signal, finding it an arbitration mode, and, if wanting the right of use for the transmission line, outputs a high logical level to the transmission line 17 (i.e., switch 32 turns off, accordingly) during bit 0 (b0) after power supply time period ta′ has passed. Afterwards, in order to try to acquire the right of use for the transmission line, the terminal number (binary number) of that terminal is output, bit-by-bit, during the time period from bit 1 to 6 shown in FIG. 8. This is detailed later.

Next, an example of a serial data configuration of a single byte to be sent via the transmission lines 17 and 18 in the start-stop serial transmission mode is shown (see FIG. 7).

Start bit, bs: a fixed low logical level

Data bits, b0 through b7

Parity bit, bp

Stop bit, bt: a fixed high logical level

With this configuration of 11-bits of data including the start bit bs to the stop bit bt, eight-bits of data or one byte of data is transmitted and received. Each of these bits is configured with the signal transmission time period tb and the power supply time period ta as described above. The transmission line 17 is driven to a low logical level during the signal transmission time period within the start bit bs solely by the switch 22 in the power supply and bus controller unit 10. Since this start bit bs allows each terminal to find the start of each byte, which is to be input or output, each terminal is capable of receiving and transmitting byte data in sync with the signal transmission time period tb and the power supply time period ta. As shown in FIG. 2, the ON/OFF control of the switch 22 is performed by the microprocessor 27. As shown with ‘SIGNALS ON THE TRANSMISSION LINE’ in FIG. 7, the signal transmission time period tb within the start bit is forcefully driven to a low logical level, and during the subsequent signal transmission time periods tb of bit 0 to bit 7, either low or high logical level bit data is transmitted from a single terminal. In such a condition, the microprocessor 27 turns on the switch 22 (see FIG. 2) so as to drive the line to a low logical level during the signal transmission time period tb within the start bit bs and the bus arbitration identification time period td within start bit bs in the bus arbitration mode within every byte cycle (11×tc).

As described above, distinction of bytes in the bus arbitration mode from bytes in data transmission among terminals (hereafter, referred to as ‘data transmission mode’) can be found based on the difference of the lengths of the first low logical level time period within the start bit of one byte of data to be transmitted. In other words, the length of the first low logical level time period within the start bit in the bus arbitration mode is defined as the bus arbitration mode identification time period td, while in the data transmission mode it is defined as the signal transmission time period tb.

FIG. 8 shows a signal configuration on the transmission line 17 in the bus arbitration mode. Only the switch 22 in the power supply and bus controller unit 10 (see FIG. 2) drives the transmission line 17 to a low logical level during the bus arbitration mode identification time period td within the bus arbitration start bit. The switch 22 is controlled by the microprocessor 27. This bus arbitration mode identification time period td, which does not exist in the data transmission mode, allows each terminal to be accurately synchronized with the start of a byte.

Continuing and referencing FIG. 8, the signal configuration on the transmission line 17 in the bus arbitration mode is described. A biased terminal number (which is described later) is assigned to bit 0 (b0) through bit 7 (b7) following the start bit (td, ta′) in the bus arbitration mode. Although bit 0 is fixed to a high logical level in this embodiment, the present invention is not limited to this.

A terminal wanting to output data to the transmission lines 17 and 18 first determines that bit 0 (b0) in the bus arbitration mode is a high logical level. This processing is executed in such a manner as follows. That is, since the transmission line 17 is connected to the input port (not shown) of the microprocessor 37 (see FIG. 3), the logical level on the transmission line 17 is coupled to the aforementioned input port, and the microprocessor 37 determines whether the logical level input to the input port is a high logical level or a low logical level. As a result, if bit 0 (b0) is a high logical level, the terminal number of that terminal itself (one of 6-bit value ranging from 0 to 62) is transmitted to the transmission line 17 on a bit-by-bit basis during the signal time periods between bit 1 through bit 6 (b1 through b6). During transmission of a single bit of that terminal number, determination is made whether or not the logical level on the transmission line 17 input to the input port matches the logical level of the transmitted single bit. If no match is found, since this means that the request for usage of the transmission line 17 issued by that terminal has not been received, that terminal number is again transmitted, compared, and identified during subsequent bus arbitration mode time periods. If a match is found, the subsequent bit value of that terminal number is transmitted during the subsequent signal time period, and subjected to the same comparison process; this transmission and identification process is repeated until the very last bit of that terminal number is matched. As a result, if all of the bits transmitted match, this means that that terminal has successfully obtained the right of use for the transmission line.

The procedure described above is detailed. If the digit weighted with 2⁽⁶⁻ⁿ⁾ within a terminal number (binary number) for the bit time period of bn (n=1 to 6) is 0, a low logic level is output (by turning the switch 32 on). Otherwise, if it is 1, a high logic level is output (by turning the switch 32 off). In the case where the microprocessor 37 determines a logic level on the transmission line during a high logic level output bit time period and finds it to be a low logic level, since this means that there is another terminal with a higher priority for accessing the transmission line, this terminal stops outputting a low logic level during the subsequent bit periods. Note that there is a possibility that a plurality of terminals simultaneously outputs a low logic level only during the time periods of bits 1 to 5 (b1 to b5) when this terminal number is output. Since the bits of a terminal number (binary number) are output on a bit-by-bit basis in a decreasing order from the most significant bit, and each digit value of 0 has a higher order of priority, the smaller the value of the terminal number, the higher the priority that terminal has for using the transmission line. Consequently, the terminal number ‘0’ has the highest degree of priority; the larger the terminal number is, the lower the degree of priority assigned to it.

When the output and identification of a terminal number during the time periods of bit 1 to bit 6 (b1 to b6) results in a single terminal acquiring the right of use for the transmission lines, as shown in FIG. 8, during the time period of bit 7 (b7), the terminal transmits to the transmission line 17 the number of the data to be transmitted next. If the bit value transmitted during the time period of bit 7 (b7) is a low logic level, the number of data bytes to be transmitted is defined as one, for example, while if it is a high logic level, the number of data bytes to be transmitted is defined as 9 which includes eight-bytes data and a checksum byte, for example. Such a designated number of data bytes are to be transmitted during a time period in the data transmission mode after the bus arbitration mode. Note that even if during that eight-byte data transmission one bit thereof is accidentally inverted through the influence of external noises, the position of that inverted bit within those eight bytes can be located based on the checksum byte value and a parity bit that indicates a parity error, and then corrected.

(Method of Providing Fair Order of Priority)

At the time of outputting a terminal number while in the bus arbitration/acquisition mode as described above, the order of priority for providing the right of use for the transmission lines is fixed. In order for each terminal to have a fair degree of priority, the bus controller is allowed to change the order of priority by outputting a priority bias value (between 3 and 62). Each terminal receives this priority bias value from the bus controller 10, and calculates a biased terminal number (hereafter, referred to as a ‘biased terminal number’) according to the value received. A terminal, which wants to obtain the right of use for the transmission lines during the time period in the bus arbitration mode, outputs its own biased terminal number during the periods between bit 1 (b1) and bit 6 (b6) (see FIG. 8). A procedure for calculating a biased terminal number is shown below. Here, assuming that: BTN denotes a biased terminal number; TN denotes a terminal number; and PBV denotes a priority bias value.

If TN≧PBV, 1.

BTN=TN−PBV+3 and the range of the BTN is [3, 62].

If TV<PBV, 2.

BTN=63+TN−PBV and the range of the BTN is [4, 62].

Note that only terminals with terminal numbers 3 through 62 are allowed to change the degrees of priority, and, terminals with terminal numbers 0 through 2 are not effected by any priority bias value. Since the bus controller 10 itself is not effected by the priority bias value it can recognize the terminal with the number 0 that has the highest degree of priority. Any terminal not obtaining the right of use for the transmission lines is capable of calculating which terminal is currently outputting data, since it receives a priority bias value and a biased terminal number (from the microprocessor 37 (FIG. 3)). This calculation procedure is shown below.

If PBV≦(65−BTN), 1.

TN=PBV+BTN−3, and the range of the TN is [3, 62].

If PBV>(65−BTN), 3.

TN=PBV+BTN−63 and the range of the TN is [3, 61].

Next, with reference to FIG. 9, the bus arbitration/continuous in-use mode is described. This mode is one that is used to continuously utilize the transmission lines when: a terminal, which has obtained the right of use for the transmission lines during the bus arbitration/acquisition mode, outputs data; and the same terminal subsequently wants to continue to output subsequent data. First, that terminal detects that the bus controller 10 has output a td signal, which indicates the start of the bus arbitration mode, and then outputs a low logic level signal to the transmission line 17 during the tb time period within bit 0 after the ta′ time period (i.e., a power supplying time period). Afterwards, a high logic level signal is output to the transmission line 17 during the tb time period within bit 1, and microprocessor 37 of that terminal then receives the logic level on the transmission line 17, and determines whether or not the output signal and the received signal match. A terminal number is then output during time periods between bit 2 (b2) and bit 7 (b7), and performs the same matching process as described earlier. If all of the output bits of that terminal number match all the received bits, this means that that terminal has obtained the right of use for the transmission lines.

With reference to FIG. 10, the bus arbitration/re-transmission mode is described. This mode is one that requests a terminal to re-transmit the data output previously when another terminal has failed to receive it. First, the transmitting terminal detects that the bus controller 10 has output a td pulse, which indicates the start of the bus arbitration mode, and then outputs to the transmission line 17 a low-level logic level signal during the tb time period within bit 0 after the ta′ time period elapses (i.e., the power supply time period). A low logic level signal is then output to the transmission line 17 during the tb time period within bit 1. Afterwards, the terminal number is output, and whether there is a match thereof is determined as described above during the time periods between bit 2 (b2) and bit 7 (b7). When this bus arbitration/re-transmission mode is detected, the terminal that has output data re-outputs data again. Therefore, even if there is a terminal that failed to receive data, correct data can be received by this re-transmission of data.

(Distributed Processing and Synchronization of Clocks)

In the case of performing measurement and control of equipment by a distributed plurality of terminals, all of the terminal clocks need to be synchronized. To do this, the terminal with terminal number 0 (which may be implemented within, for example, the bus controller 10 according to this embodiment) periodically outputs data for time adjustment, and the other terminals are synchronized to that time, so that all of the terminal clocks can be synchronized to count with the same accuracy for instruction execution by microprocessor 37.

Since transmission among terminals can be carried out freely, in the case where a specific sensor, for example, is used in a terminal while an actuator is used in another terminal, the terminal to which the sensor is connected can hold an input signal from the sensor and its input time information while the other terminal to which the actuator is connected can hold the output signal to the actuator and its output time information, thus allowing distributed terminals to transmit to each other while corresponding their input and output signals in accordance with their time information. Therefore, synchronous control of a sensor and an actuator can be carried out.

Even in the case of periodically collecting data from each terminal at the same time, time synchronization is needed; this can also be implemented using the aforementioned method.

Furthermore, with connection of a specific terminal to a man-machine interface such as a keyboard, a display unit, or a warning device, it is possible for users to issue, via that terminal, a command for a plurality of remote terminals to control equipment and/or collect data, and to monitor them.

(Power Line and Weight Saving)

As shown in FIG. 11, an additional pair of power lines are deployed; a terminal is deployed at the place where equipment consuming electric power and needing to be controlled is deployed so that the terminal controls the equipment; with this configuration of interconnecting one pair of power lines and two lines shared for data transmission and power supply according to the present invention, control of a plurality of equipment can be carried out.

In the case where a relatively short lifetime lamp or motor is connected to the equipment, and when maintenance on the equipment is necessary, sensors are deployed in the equipment, and an accumulated energized time, an ON count, the open and close count of a relay, the count of repetitive operations of equipment, etc. are stored in the terminal. This allows giving a prior warning of failure (disconnection) or an abnormal state, a notice that the lifetime of the equipment may be nearing its end, and also allows sensor information stored in that terminal to be taken out and analyzed later in order to carry out root cause analysis of defects and investigation of access frequency.

Weight saved wiring to movable bodies such as a car or an airplane, or operational parts such as a robot or a machine is needed. In this case, according to a method of the present invention, only two power lines and two control lines are needed so that weight saving thereof can be attained.

(Deployment of Terminals on Linear Transmission Lines)

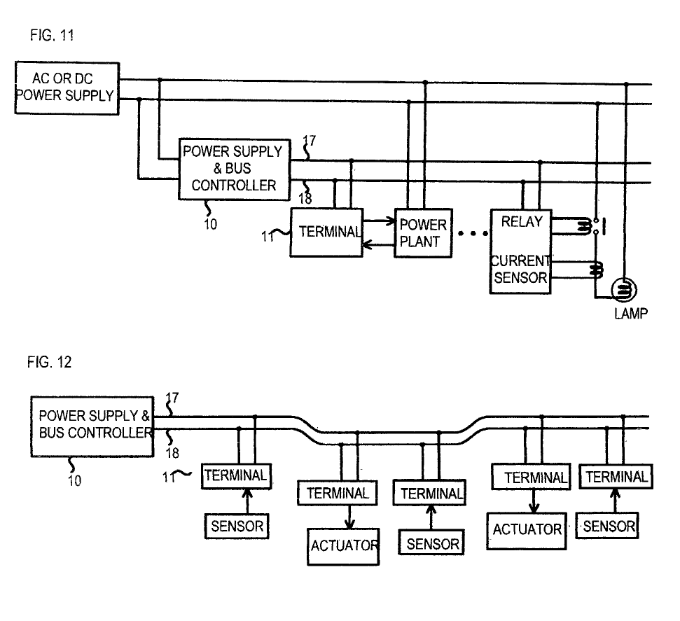

As shown in FIG. 12, by pre-connecting terminals, which connect to sensors, actuators, LEDs, etc., to a linear pair of transmission lines, and by providing this pair of transmission lines (electric wires) as an adjunct or accessory, those terminals are deployed at the same time. In particular, it is easy to spatially provide a plurality of temperature sensors, etc. as an adjunct or accessory; if those sensors, etc. are comparatively light, the electric wires by themselves can support them.

(Summary of Operation of Power Supply and Bus Controller)

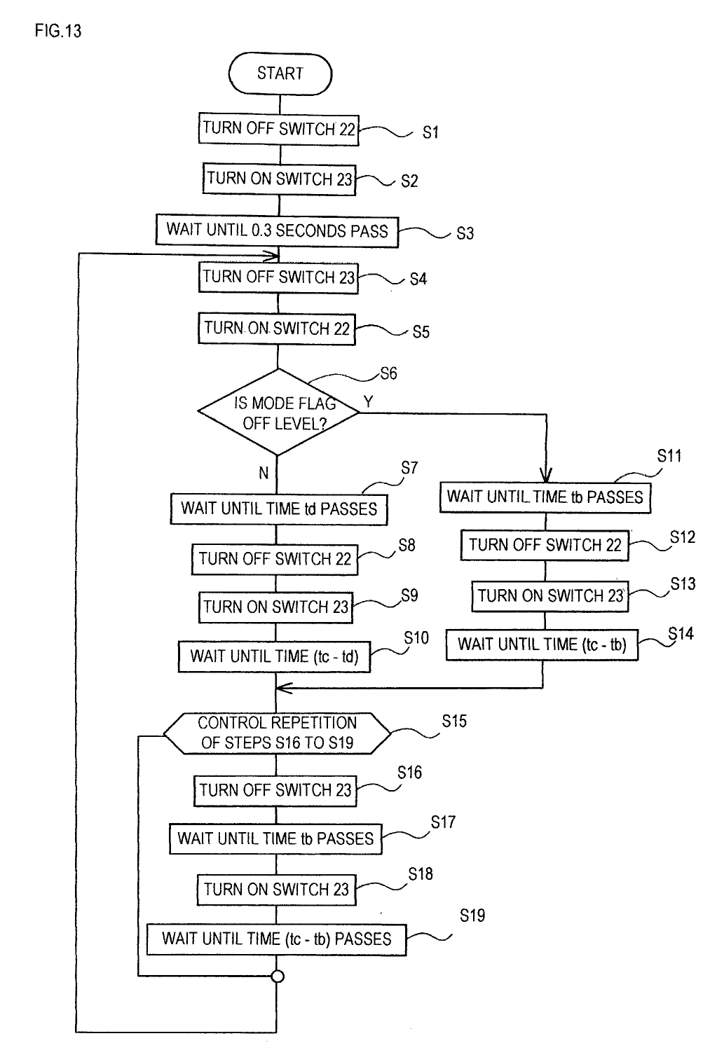

With reference to FIG. 13, the summary of an operation of the power supply and bus controller unit 10, according to an aspect of the present invention, is described below. One of the important operations of the power supply and bus controller unit 10 is to output start bits to the two-line bus 17 for each terminal.

After the power supply and bus controller unit 10 is energized, in step S1, the switch 22 turns off. In step S2, the switch 23 is turned on so as to supply electric power to the terminals via the two-line bus 17. In step S3, the power supply and bus controller unit 10 initializes a mode flag (not shown) to a logical high level (ON level), which resides, for example, in the microprocessor 27,and waits until 0.3 seconds passes. This ON level mode flag denotes the bus arbitration mode. In step S4, the switch 23 turns off so as to stop supplying electric power. In step S5, the switch 22 turns on so as to output a low-level start bit. In step S6, whether or not the mode flag is set to the OFF level is determined. If the mode flag is not set to the OFF level, this process proceeds to step S7. Otherwise, if the mode flag is set to the OFF level, this process proceeds to step S11.

The process from step S7 to S10 establishes a start bit that includes a low-level time period td and a power supply time period (tc−td), for a bus arbitration mode. In step S7, the power supply and bus controller unit 10 waits until time td passes, and then turns off the switch 22 in step S8 so as to establish the low-level time period td. In step S9, the switch 23 is turned on so as to start supplying electric power to terminals via the two-line bus 17. In step S10, the bus controller 10 waits until time (tc−td) passes. This process then proceeds to Step S15.

On the other hand, the process from step S11 to S14 establishes a start bit that includes a low-level time period tb and a power supply time period (tc−tb), for a data transmission mode. In step 11, the power supply and bus controller unit 10 waits until time tb passes, and then turns off the switch 22 in step S12 so as to establish the low-level time period tb. In step S13, it turns on the switch 23 so as to start supplying electric power to terminals via the two-line bus 17. In step S14, the power supply and bus controller unit 10 waits until time (tc−tb) passes. This process then proceeds to Step S15.

The process from step S15 and S19 establishes a single byte cycle from bit b0 to bit bt by repeatedly stopping and starting the power supply to terminals via the two-line bus (17 and 18) ten times. In step S15, executing steps S16 to S19 ten times is controlled. In step S16, the switch 23 is turned off so as to stop supplying electric power to the two-line bus. In step S17, while the power supply and bus controller unit 10 is waiting for time tb to pass, it also senses the level on the transmission line 17 during the time tb so as to set the mode flag described above to a specific level in conformity with the sensed level. In step S18, the switch 23 is turned on so as to start supplying electric power. In step S19, it waits until time (tc−tb) passes. The process from step S16 to S19 is repeated ten times, and then proceeds to step S4.

(Summary of Operation of Low-level Software Driver for Terminals)

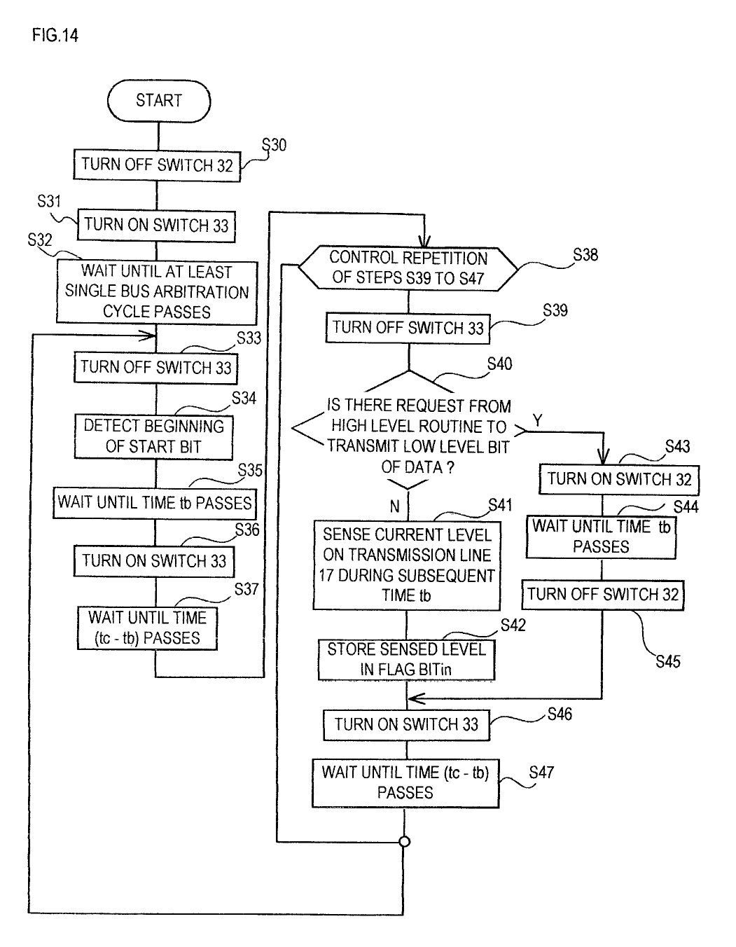

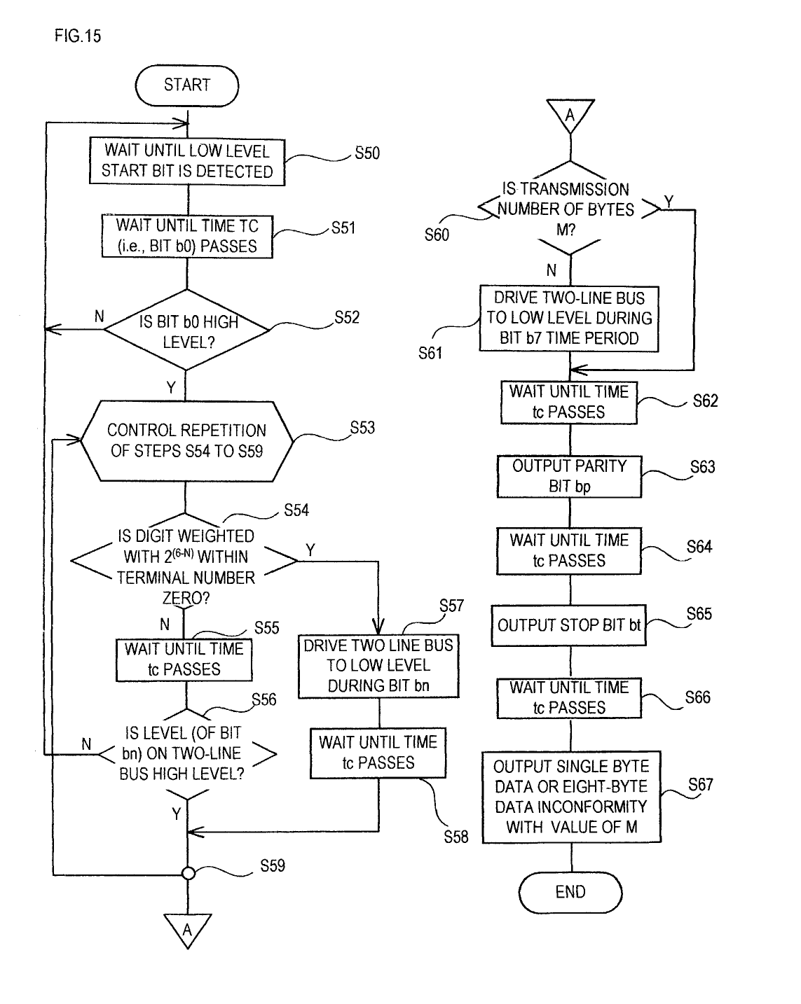

With reference to FIG. 14, the summary of an operation of each terminal (11 through 16) according to an aspect of the present invention is described below. The flowchart of FIG. 14 shows an operation of a low-level software driver that controls the charging of a capacitor 35 with electric power provided via the two-line bus, and receives and transmits data from/to the two-line bus. This software routine runs continuously on a time-sharing basis in conjunction with a high-level software routine (application) for terminals, which is detailed later.

After the terminal is energized, it turns off the switch 32 in step S30. In step S31, it turns on the switch 33 so as to receive and charge electric power to the capacitor 35. In step S32, the terminal waits at least until a single bus arbitration cycle passes. The process from step S33 to S37 establishes a start bit that includes a low-level time period tb and a power supply time period (tc−tb), for either the bus arbitration mode or the data transmission mode. In step S33, the switch 33 is turned off so as to stop receiving and charging electric power. In step S34, the terminal detects that the two-line bus level transitions from a high level to a low level, or the beginning of a start bit provided by the power supply and bus controller unit 10. In step S35, the terminal waits until time tb passes. In step S36, the switch 33 is turned on so as to resume charging the capacitor 35. In step S37, the terminal waits until time (tc−tb) passes. Then, the process from step S38 to S47 is repeated ten times so as to receive or transmit a single byte including bit b0 to bit bt from/to the two-line bus. In step S38, the process of repeating steps S39 to S47 is controlled. In step S39, the switch 33 is turned off. In step S40, it is determined whether there is a request from a high-level routine (shown in FIG. 15 and described later) to transmit low-level bit data. In actuality, this request is represented by a digital value stored in a flag BITout (not shown), which is used to interface with the high-level routine described above. If the flag BITout is 0 (low-level), this process proceeds to step S43; otherwise, if the flag is not 0, this process proceeds to step S41.

In step S43, the switch 32 is then turned on so as to drive the two-line bus 17 to a low level. In step S44, the terminal waits until time tb passes. In step S45, the switch 32 is turned off, and the flag BITout is set to 1. This Process Then Proceeds to Step S46.

On the other hand, if the flag is not 0, in step S41, the terminal senses the current level of the transmission line 17 during subsequent time tb. In step S42, the sensed level is stored in a flag BITin (not shown), which is used to interface with the high-level routine described above.

In step S46, the switch 33 is turned on so as to resume charging the capacitor 35. In step S47, the terminal waits until time (tc−tb) passes. The process from step S39 to S47 is repeated ten times, as described above. Afterwards, this process returns to step S33.

(Summary of High-level Software Application for Terminals)

In the following, a terminal transmission operation in the bus arbitration/acquisition mode and the data transmission mode is described while referencing FIG. 15.

The process from step S50 to S59 is a process to acquire the right of utilization of the two-line bus. In step S50, the terminal waits until detection of a low-level start bit, bs, which continues for time td and which is output from the power supply and bus controller unit 10. In step S51, the terminal waits until time tc (i.e., bit b0) passes. In step S52, it is determined if the bit b0 is a high level by checking the flag BITin. If the bit b0 (BITin) is a high level, this process proceeds to step S53; otherwise if it is not, the process goes back to step S50.

The process from step S53 to S59 is a process in which a terminal outputs its number to the two-line bus in order to acquire the right for utilization of the two-line bus. In step S53, the process of executing steps S54 to S59 six times is controlled. A control variable n is then set to 1. In step S54, the terminal determines whether the digit weighted with 2⁽⁶⁻ⁿ⁾ within its own terminal number is zero. If it is zero, this process proceeds to step S57; otherwise, if it is not, the process proceeds to step S55. In step S57, the flag BITout is set to 0 so as for the terminal to drive the two-line bus to a low level during bit bn. In step S58, the terminal waits until time tc passes. In step S59, the control variable n is incremented by one, and if the incremented value n is equal to or less than six, this process goes back to step S54.

On the other hand, in step S55 the terminal waits until time, tc passes. In step S56, whether or not the level (of bit bn) on the two-line bus is a high level is determined by checking the flag BITin. If it is a high level, this process proceeds to step S59; otherwise, if it is not, this means that the terminal has failed to acquire a right for utilization of the two-line bus, and this process goes back to step S50. In step S59, as described above, the control variable n is incremented by one, and if the incremented value n is equal to or less than six, this process goes back to step S54; otherwise, if it is not, this process proceeds to step S60, which means that the terminal has successfully obtained the right for utilization of the two-line bus.

In step 60, it is determined whether the transmission number of bytes is M (M is predetermined to be, for example, eight). If the number is M, this process proceeds to step S62; otherwise, if the number is not M, this process proceeds to step S61. In step S61, in order to drive the two-line bus to a low level during the bit b7 time period, the flag BITout is set to 0 (low level). This bit b7 indicates whether the terminal is going to transmit either a single byte of data or M-byte amount of data. In step S62, the terminal waits until time tc passes. In step S63, in order to output a parity bit bp, the flag BITout is set to the level of this parity bit bp. In step S64, the terminal waits until time tc passes. In step S65, in order to output a stop bit bt, the flag BITout is set to the level of this stop bit bt. In step S66, the terminal waits until time tc passes, and the bus arbitration/acquisition mode is over.

In step S67, in sync with a start bit bs, which is output from the power supply and bus controller unit 10, the terminal outputs either a single byte of data or eight-byte data inconformity with the value of M.

While the present invention has been described by disclosing a plurality of embodiments, these embodiments are provided only for explaining the present invention, and the present invention is not limited to these embodiments. Those skilled in the arts will recognize that all modifications, replacements, and equivalents falling within the spirit and scope of the attached claims are included within the present invention.

What is claimed is:

1. A data transmission method utilizing a two-line bus shared for power supply and data transmission, comprising the steps of:
transmitting single-bit data to a two-line bus during a first time period;
supplying electric power to said two-line bus during a second time period, with said first time period being continuous with said second time period.

2. The transmission method, according to claim 1, wherein said two-line bus is electrically pulled up.

3. The transmission method, according to claim 2, further comprising a step of arbitrating requests for right of use for said two-line bus from a plurality of terminals; wherein said plurality of terminals are connected to said two-line bus.

4. The transmission method, according to claim 3, wherein said step of arbitrating comprises the steps of:
outputting, by a bus controller, a predetermined logical level that indicates the start of arbitration to said two-line bus during a first time period; and
detecting a predetermined single-bit logical signal output to said two-line bus that indicates the start of arbitration by at least one terminal of said plurality of terminals, which wants to acquire right of use for said two-line bus, and outputting the terminal number of that terminal on a bit-by-bit bases to said two-line bus, and receiving the logical signal value on said two-line bus in sync with this output, and comparing the received logical signal value to corresponding bit values.

5. The transmission method, according to claim 4, wherein said terminal number is calculated based upon a priority bias value output to said two-line bus from said bus controller and the inherent terminal number of each terminal itself.

6. The transmission method, according to claim 4, further comprising the steps of:
outputting data for time adjustment to said two-line bus by said bus controller; and
inputting said data for time adjustment output to said two-line bus and performing time adjustment by each of said plurality of terminals.

7. A data transmission apparatus utilizing a two-line bus shared for power supply and data transmission, comprising:
a two-line bus;
at least one terminal connected to said two-line bus;
a bus controller, which is connected to said two-line bus and which outputs a predetermined single-bit logical signal that indicates the start of data transmission to said two-line bus or the start of arbitration of requests for right of use of said two-line bus during a first time period and which supplies electric power during a second time period, wherein said first time period is continuous with said second time period.

8. The transmission apparatus, according to claim 7, wherein said two-line bus is electrically pulled up.

9. The transmission apparatus, according to claim 7, wherein, at least one terminal, a terminal wanting to acquire said right of use of said two-line bus detects a predetermined single-bit logical signal output to said two-line bus that indicates the start of arbitration of requests for right of use of said two-line bus, outputs to said two-line bus a series of bits of the terminal number of that terminal on a bit-by-bit basis in order, and receives the logical level value on said two-line bus in sync with this outputting, and compares it with the corresponding output bit values.

10. The transmission apparatus, according to claim 9, wherein said terminal number is calculated based upon a priority bias value output to said two-line bus from said bus controller and the inherent terminal number of each terminal itself.

11. The transmission apparatus, according to claim 7, wherein said bus controller further outputs data for time adjustment to said two-line bus, and at least one terminal, according to the present invention, inputs said data for time adjustment, which was output to said two-line bus so as to perform time adjustment.

12. The transmission apparatus, according to claim 7, wherein predetermined equipment is connected to at least one terminal, according to the present invention, and electric power lines are further comprised for said equipment.

13. The transmission apparatus, according to claim 7, wherein the topology of said two-line bus includes a linear configuration.
